(19) United States
(12) Patent Application Publication
(10) Pub. No.: US 2003/0219262 A1
(43) Pub. Date: Nov. 27, 2003

(54) Toner supply device, toner cartridge and method for discriminating authenticity of toner cartridge

(75) Inventor: Yohei Doi, Yokohama-shi (JP)

Correspondence Address: FOLEY AND LARDNER, SUITE 500, 3000 K STREET NW, WASHINGTON, DC, 20007, US

(73) Assignee: TOSHIBA TEC KABUSHIKI KAISHA

(21) Appl. No.: 10/153,881

(22) Filed: May 24, 2002

(51) Int. Cl. G03G 15/00

(52) U.S. Cl. 399/12; 399/13

(57) ABSTRACT

A toner supply device used for an image forming system for forming images with toner, for supplying the toner to the image forming system from a toner cartridge containing the toner is disclosed. A genuine toner cartridge has a cylindrical container with a toner-discharging hole formed on the outer surface of a front capped-end section of the cylindrical container and at least one protrusion portion formed on the outer surface of a rear capped-end section of the cylindrical container. The toner supply device has a cartridge holder to hold a toner cartridge in a horizontal direction, the toner cartridge being rotatable while held by the cartridge holder, a rotation driver to supply a rotary power to the toner cartridge, a detector to detect the protrusion portion of the toner cartridge, and a controller to determine whether the toner cartridge has been attached based on a result of detection from the detector, rotate the toner cartridge via the rotation driver when determined that the toner cartridge has been attached, measure a length of the protrusion portion in a circumferential direction based on a result of detection from the detector during rotation of the attached toner cartridge, and compare a result of the measurement with a length of the protrusion portion of the genuine toner cartridge, thus determining whether the attached toner cartridge is a genuine one.

### BACKGROUND OF THE INVENTION

The present invention relates to a toner supply device, a toner cartridge and a method of determining whether a toner cartridge is a genuine or pirated one.

Toner quality has been improved as one of major factors in image-quality enhancement, in use for image forming systems such as a copying machine, a facsimile machine and a printer. Manufacturers have offered toner matching their product specifications best only as genuine ones.

Particular types of toner have been on the market recently, which match the least specifications shared by image forming systems offered by several manufacturers. Such a particular type of toner (called a pirated one) that matches a part of the specifications could cause inferior image quality and give adverse effects to photosensitive drams as image carriers and developers, thus resulting in low system reliability.

Japanese-Unexamined Patent Publication No. 9-18531, for example, discloses a method of detecting a toner cartridge containing a pirated toner (which is hereinafter called a pirated toner cartridge). This method of determining whether a toner cartridge is a genuine or pirated one offers a specific type of toner cartridge, an uneven surface formed thereon with a logo for a manufacturer, etc. Several switches arranged on an image forming system are turned on/off when a toner cartridge is attached, to detect the toner cartridge and determine whether the toner cartridge is a pirated one.

A plurality of switches and sensors provided for detection of pirated toner cartridges like this method, however, cause complicated system configuration and hence increase in cost for image forming systems.

### SUMMARY OF THE INVENTION

The purpose of the present invention is to provide a simple-structured toner supply device having functions of detecting a toner cartridge when attached to this device and also determining whether the attached toner cartridge is a genuine one, a toner cartridge and a method of determining whether a toner cartridge is a genuine or pirated one.

According to a first aspect of the present invention, there is provided a toner supply device used for an image forming system for forming images with toner, for supplying the toner to the image forming system from a toner cartridge containing the toner, a genuine toner cartridge having a cylindrical container with a toner-discharging hole formed on an outer surface of a front capped-end section thereof and at least one protrusion portion formed on an outer surface of a rear capped-end section thereof, the toner supply device comprising: a cartridge holder to hold a toner cartridge in a horizontal direction, the toner cartridge being rotatable while held by the cartridge holder; a rotation driver to supply a rotary power to the toner cartridge; a detector to detect the protrusion portion of the toner cartridge; and a controller to determine whether the toner cartridge has been attached based on a result of detection from the detector, rotate the toner cartridge via the rotation driver when determined that the toner cartridge has been attached, measure a length of the protrusion portion in a circumferential direction based on a result of detection from the detector while the attached toner cartridge is rotating, and compare a result of the measurement with a length of the protrusion portion of the genuine toner cartridge, thus determining whether the attached toner cartridge is a genuine one.

According to a second aspect of the present invention, there is provided a toner cartridge used in a toner supply device for supplying toner to an image forming system for forming images with the toner, the toner supply device having a rotation driver for supplying a rotary power to the toner cartridge and a detector for detecting at least components of the toner cartridge, the toner cartridge comprising: a cylindrical container having a spiral protrusion formed on an inner surface thereof, a toner-discharging hole formed on an outer surface of a front capped-end section thereof, and at least one protrusion portion, having a specific length, provided on outer surface of a rear capped-end section thereof, to be used for determining whether the toner cartridge is a genuine one, wherein the protrusion portion is located at a position which is detectable by the detector when the toner cartridge has been attached to the toner supply device, and the length of the protrusion portion is measured based on a result of detection by the detector and sent to the toner supply device, as information indicating that the toner cartridge is a genuine one.

According to a third aspect of the present invention, there is provided a method of determining whether a toner cartridge attached to a toner supply device is a genuine one, the toner supply device being used for an image forming system for forming images with toner, the method comprising: assembling a genuine toner cartridge with a cylindrical container having a toner-discharging hole formed on an outer surface of a front capped-end section of the cylindrical container, and at least one protrusion portion, having a specific length, formed on an outer surface of a rear capped-end section of the cylindrical container; detecting whether the protrusion portion exists to determine whether a toner cartridge has been attached; and when determined that the toner cartridge has been attached, measuring a length of the protrusion portion of the attached toner cartridge and comparing the measured length with the specific length for the genuine toner cartridge.

### BRIEF DESCRIPTION OF THE DRAWINGS

In the drawings:

FIG. 1 is a sectional view showing the whole construction of a copying machine as an image forming system, to which a toner supply device according to the present invention is applied;

FIG. 2 is a schematic diagram showing a principal part of the copying machine shown in FIG. 1;

FIG. 3 is an exploded perspective view showing the details of a cylindrical container and a cap which constitute a toner cartridge;

FIG. 4 is an exploded perspective view showing a driving unit of a toner supply device;

FIG. 5 is a perspective view showing a toner cartridge while being inserted into an inlet holder;

FIG. 6 is a sectional view showing a toner cartridge immediately before being attached;

FIGS. 7A through 7C are sectional views showing the operation of detaching a toner cartridge;

FIG. 8 is a perspective view showing the toner cartridge and a drive unit assembled each other with a holder;

FIG. 9 is a perspective view showing the toner cartridge and the drive unit assembled each other without the holder;

FIG. 10 is a side view showing the toner cartridge and a detector;

FIG. 11 is a rear view illustrating detailed configuration of protrusion portions of the toner cartridge and also a positional relationship between these portions and the detector;

FIG. 12 shows a block diagram of components for detecting a toner cartridge and whether it is a genuine or pirated one;

FIG. 13 shows sample timing charts I to IV for signals supplied to the controller from the detector made up of a push switch;

FIG. 14 is a table showing results of whether toner cartridges have detected and they are genuine or pirated one based on the signals shown in FIG. 13; and

FIG. 15 is a flowchart indicating how to determine whether a toner cartridge has been detected and also it is a genuine one in a toner supply device of the embodiment.

### DESCRIPTION OF THE PREFERRED EMBODIMENT

An embodiment according the present invention will be disclosed with reference to the accompanying drawings.

The features of the embodiment disclosed below lie in a toner cartridge having a cylindrical container, with front and rear ends, for containing toner, having a first protrusion and a second protrusion formed on the outer surface of the cylindrical container but close to the rear end thereof and a toner supply device equipped with a detector for detecting the first protrusion when the toner cartridge is attached and also detecting the length of the first and second protrusions while the toner cartridge is rotating and a controller, based on the results of detection, for determining whether the toner cartridge has been attached and whether the attached toner cartridge is a genuine or a pirated one.

First, using a copying machine as an example of an image forming system in which a toner supply device according to an embodiment of the present invention is used, an embodiment of a toner supply device for use in the copying machine and a toner cartridge which is to be attached to the copying machine will be described with the detailed structure of the copying machine.

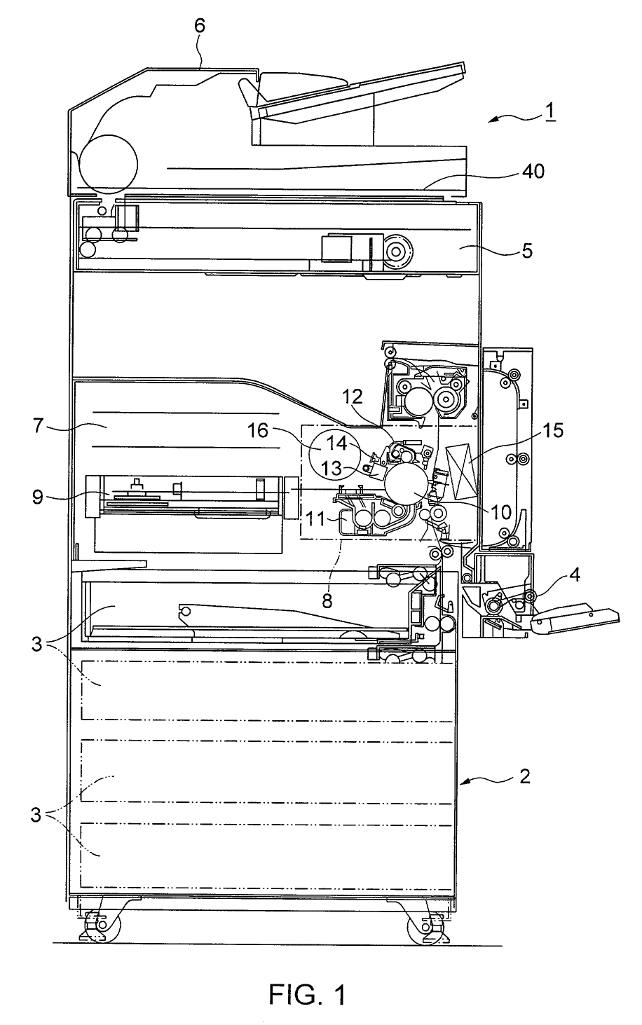

FIG. 1 is a sectional view showing the whole construction of a copying machine, in which a toner supply device according to the present invention is provided. In FIG. 1, a copying machine 1 has a paper feeding cassette device 2 for housing therein a large number of papers, in the lower portion of the body thereof. The copying machine 1 also has an LCF paper feeding device 3 for feeding a large number of papers having the same size, and a manual paper feeding device 4 capable of manually feeding various kinds of papers having various sizes.

The copying machine 1 comprises: a control panel 40 mounted on the upper section of the body thereof, an image reading part 5, provided in the upper portion, for reading a manuscript; an automatic manuscript feeding device 6 for feeding the manuscript to the image reading part 5; an image storing part 7 for storing image data read by the image reading part 5; and an optical laser system 9 for deriving the stored image data to write an image to be printed, in an image forming part 8.

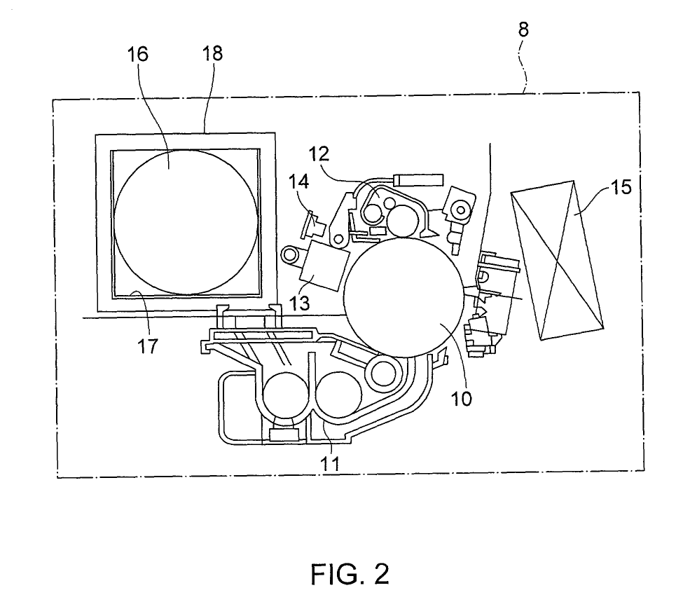

As shown in FIG. 2 in addition to FIG. 1, the image forming part 8 comprises a photosensitive material drum 10, a developing device 11, a cleaner 12, a charger 13, a charge-removing lamp 14, and a transfer/peeling charger 15. On the developing device 11, a toner cartridge 16 for supplying a toner, and a driving part 17 (not shown in FIGS. 1 and 2) for rotating the toner cartridge 16 are attached.

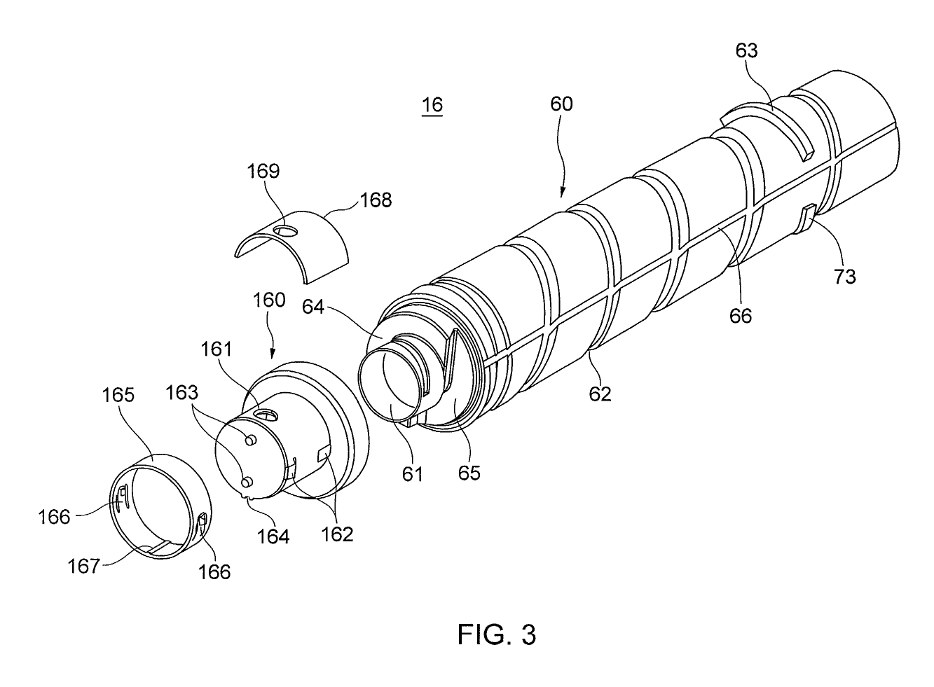

Referring to FIG. 3, the detailed construction of the toner cartridge 16 will be described. In FIG. 3, the toner cartridge 16 comprises a cylindrical container 60 serving as a body, a cap 160 serving as a toner discharging part, and a discharging hole shielding cover 165.

The cylindrical container 60 has a cylindrical shape with a bottom. At least on the inner peripheral surface of the cylindrical container 60, there is formed a spiral protrusion (not shown) for gradually feeding a toner, which is previously filled, toward an opening portion 61 as the cylindrical container 60 rotates. In a preferred embodiment shown in FIG. 3, the cylindrical container 60 is formed of a synthetic resin by the blow molding, so that a spiral groove 62 is formed in the outer peripheral surface of the cylindrical container 60 so as to correspond to the spiral protrusion for guide.

The cylindrical container 60 has two grooves 66 formed on the outer opposing wall sections thereof along the same diameter. The direction of attaching the cylindrical container 60 is decided with the grooves 66. In addition, the cylindrical container 60 has two curved protrusion portions 63 and 73 provided at specific locations close the bottom section thereof, separated from each other by a specific distance. Whether the toner cartridge 16 is attached and whether the attached toner cartridge is a genuine one or a pirated one are determined with these protrusion portions 63 and 73. The protrusion portion 73 is provided almost at the middle outer surface between two grooves 63. The protrusion portions 63 and 73 will be disclosed later in detail.

The opening portion 61 of the cartridge 16 is formed at the center of a stepped portion 64 and projects therefrom so as to have a predetermined diameter. A part of the stepped portion 64 is formed with a positioning cut-out portion 65 for integrating the container 60 with the cap 160 so as to establish a predetermined relationship between the positions of a discharging hole 161, which will be described later, and the positioning portions 63 when the cap 160 is mounted on the cylindrical container 60.

The cap 160 has a shape having a stepped portion, which corresponds to the shape of the periphery of the opening portion 61 of the cylindrical container 60, as a whole. The cap 160 has the discharging hole 161 at an arbitrary position on the peripheral wall thereof. The cap 160 is provided for supplying one dose of the toner when the cap 160 is rotated by a half rotation from the initial position to face downwards during the rotation of the toner cartridge 16 after the cap 160 is mounted on the cylindrical container 60. At positions shifted from the discharging hole 161 by 90 degrees in the peripheral wall surface, two engaging portions (protrusions) 162a and 162b for engaging a discharging hole shielding cover 165, which will be described later, are provided on each of both sides. Although only the engaging portions 162a and 162b on one side are shown in FIG. 3, other two engaging portions 162a and 162b are provided at positions shifted from the engaging portions 162a and 162b on the shown side by 180 degrees. As will be described in detail later, a groove 162c is formed between the two engaging portions 162a and 162b, and the cover 165 is designed to move in the groove 162c in axial directions to contact the engaging portions 162a and 162b.

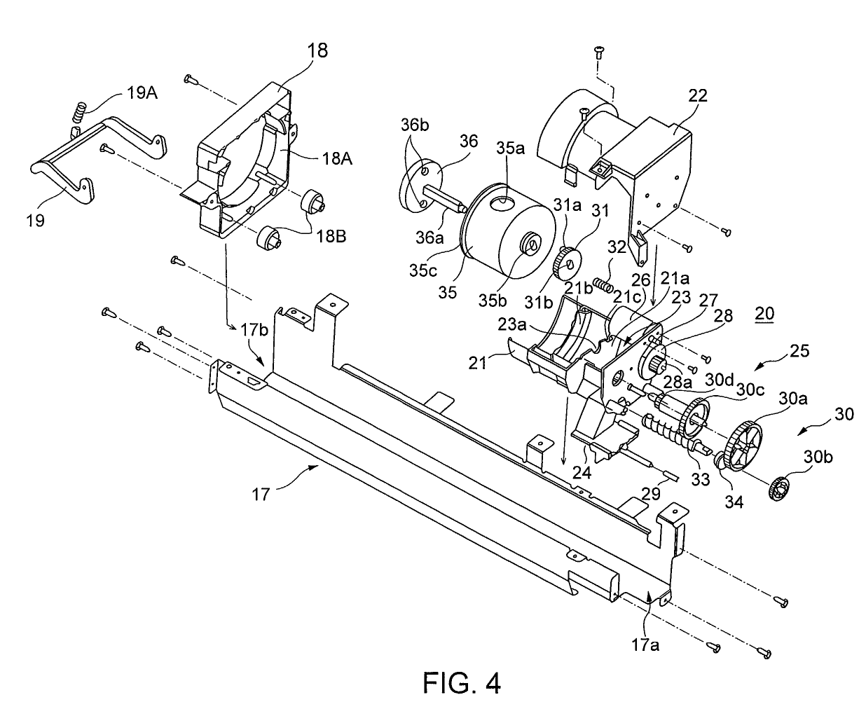

On the tip flat surface of the cap 160, there are provided protruding portions 163 serving as positioning portions for engaging positioning recessed portions (not shown) formed in a flat surface of the inner wall of a holder guide of a drive unit 20, which will be described later, to inhibit the rotational shift between the holder guide and the toner cartridge 16. In this preferred embodiment, the protruding portions 163 are formed by two bosses arranged in the radial directions corresponding to the position of the discharging hole 161. In addition, the protruding portions 163 serve to rotate the cylindrical container 60 while receiving the torque of a motor 26 (FIG. 4) which will be described later. On the opposite side of the discharging hole 161 in the radial direction in the peripheral wall of the cap 160, a guide groove 164 for guiding the axial movement of the cover 165 is formed so as to extend in axial directions.

The cover 165 for shielding and opening the discharging hole 161 has a ring shape having a predetermined diameter and a predetermined width which is greater than the diameter of the discharging hole 161. The cover 165 facing the engaging portions 162a and 162b of the cap 160 and grooves 162c has protrusions for engaging the engaging portions 162a and 162b, and elastic spring portions 166 formed by forming U-shaped cut-outs in the periphery thereof. That is, the U-shaped cut-outs are formed in the cover 165 in circumferential directions thereof to form elastic tongue pieces 166 serving as cantilevers, and inner stoppers 166a are formed on the internal and external surfaces of the tongue pieces 166 so as to be movable in the grooves 162 of the cap 160 in axial directions to abut on the protrusions 162a and 162b.

Moreover, as described above, a protruding portion 167 protruding from the inner peripheral surface of the cover 165 to extend in axial directions thereof is provided so as to correspond to the guide groove 164 of the cap 160. The protruding portion 167 is positioned by the guide groove 164 so that the cover 165 is slidable along the peripheral surface of the cap 160.

Although the discharging hole 161 is opened and closed by the sliding of the cover 165, there is a slight gap between the outer peripheral surface of the cap 160 and the inner peripheral surface of the cover 165. In order to prevent the toner from leaking from the gap while shielding the discharging hole 161, a seal 168 of an elastic material, such as felt or sponge, is applied on a portion surrounding the discharging hole 161. The seal 168 has a through hole 169 formed so as to correspond to the discharging hole 161. The construction of the toner cartridge has been described above.

Referring to FIG. 4, the construction of the drive unit 20 for rotating the above described toner cartridge 16 will be described below.

Briefly, the torque of the motor 26 is transmitted to a disk (driving plate) 36 to rotate the toner cartridge 16 since the protruding portions 163, 163 of the toner cartridge 16 are inserted into recessed grooves (driving holes) 36b, 36b formed in the disk 36. In addition, a carrier auger 33 is rotated by the motor 26 to move the toner from a chamber 23 to a hopper 24. The detailed construction of the drive unit 20 will be described below.

In FIG. 4, a cartridge receiving portion 17 is secured to the body of the copying machine 1, and is a substantially U-shaped receiving member of a metal or synthetic resin. The drive unit 20 is mounted on an end portion 17a of the U-shaped receiving portion 17 on the front side in the figure. A rectangular inlet guide 18 is secured to the other end portion 17b of the receiving portion 17 by means of a screw or the like. The inlet guide 18 has a guide hole 18A having a diameter capable of receiving the toner cartridge 16, and two rollers 18B are arranged along the periphery of the insertion opening 18A for rotatably supporting the toner cartridge 16.

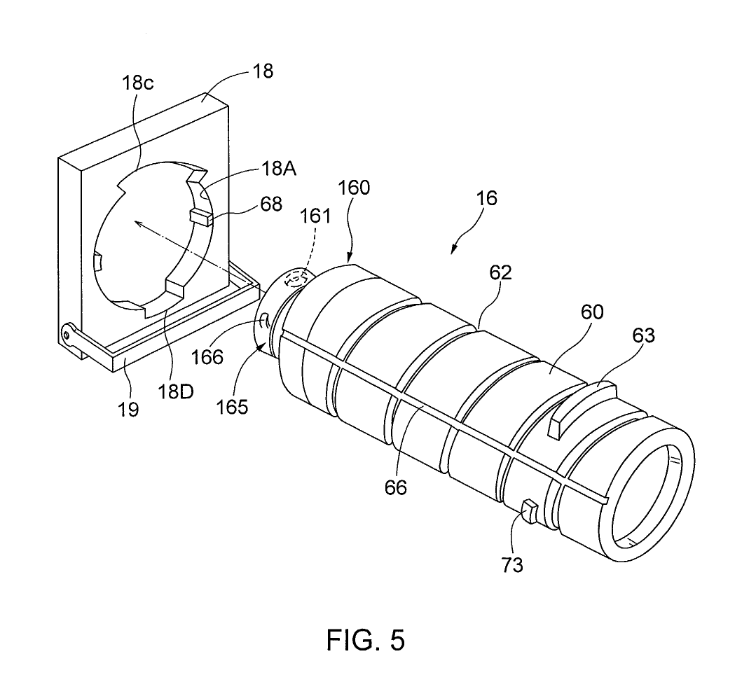

On the inlet guide 18, there is mounted a substantially C-shaped biasing lever 18 for biasing the bottom of the cylindrical container 60 toward the drive unit 20 after the toner cartridge 16 is attached. The biasing lever 19 biases the cylindrical container 60, which is inserted by a spring 19A in horizontal directions, toward the drive unit 20 from the guide 18. FIG. 5 is a perspective view schematically showing the inlet holder 18, the biasing lever 19 and the toner cartridge 16 when the toner cartridge 16 is inserted into the inlet holder 18. As shown in this figure, provided on both side faces of the inner wall of the guide hole 18A of the inlet holder 18 are protrusion portions 68, allowed to be engaged with the grooves 66 of the cylindrical container 60, to guide the container 60 into the inlet holder 18 in a predetermined direction. Formed on the upper and the lower sides of the inlet holder 18 are concavity portions 18C and 18D, allowed to be engaged with the protrusion portions 63 and 73, respectively, of the cylindrical container 60, to accept the detachable toner cartridge 16.

As shown in FIG. 4, the drive unit 20 comprises: a substantially semi-cylindrical holder 21; a holder cover 22 integrated with the holder 21 for forming a cylinder which is open toward the inlet guide 18; a chamber 23 defined by the holder 21 and the holder cover 22; a hopper 24 for supplying a toner, which is filled in the chamber 23, to the developing device 11; and a drive mechanism 25 arranged in the vicinity of the chamber 23. The holder 21 and the holder cover 22 have a shape formed by dividing a cylinder along a radius. The holder 21 has a partition wall 21a defining the chamber 23, and an engaging partition wall 21b engaging a flange portion 35c of a holder guide 35 which will be described later. The partition wall 21a has a cut-out 21c which is associated with a facing partition wall (not shown) of the holder cover 22 for forming a hole.

The drive mechanism 25 comprises a motor 26 serving as a driving source, a belt 27, a pulley 28, drive gear sets 30, 31, a spring 32, a carrier auger 33 for promoting the movement of the toner from the chamber 23 to the hopper 24, a bush 34, a holder guide 35 and a disk 36. Furthermore, reference number 29 denotes a spring mounted on a pin of a cover of the hopper 24. The drive gear set 30 comprises: a large-diameter first gear 30a; a second gear 30b which meshes with the first gear 30a and which is mounted on the carrier auger 33 via the bush 34; a third gear 30c which meshes with a gear 28a integrated with the pulley 28 outside of the chamber 23; and a fourth gear 30d mounted on one end of a shaft, on the other end of which the third gear 30c is mounted. The fourth gear 30d is arranged in the chamber 23, and is designed to mesh with the gear set 31 fixed to the holder guide 35.

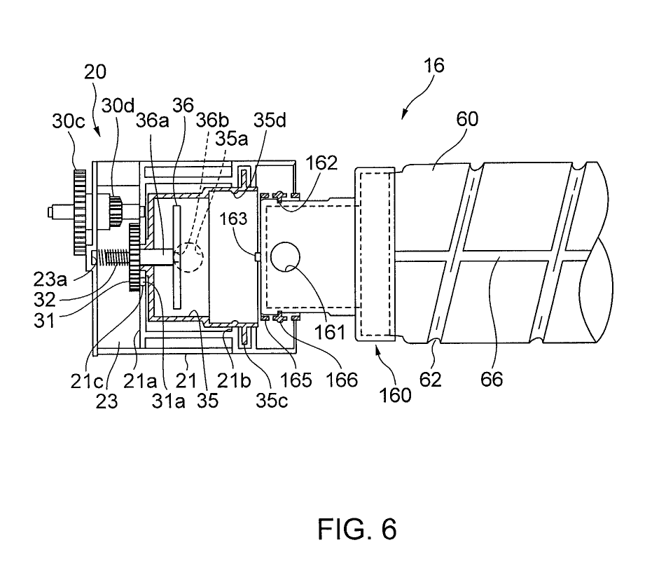

The holder guide 35 is a cup-shaped member having a diameter which is a size larger than that of the cylindrical portion at the tip of the cap 160 of the toner cartridge 16 shown in FIG. 3. The holder guide 35 has a supply hole 35a which is formed so as to have a diameter corresponding to the discharging hole 161 of the cap 160 and to correspond to the position of the discharging hole 161 of the cap 160. The central portion of the bottom of the holder guide 35 protrudes in the form of a boss, in which an elliptically shaped hole 35d is formed. The disk 36 has a shaft 36a having a D-shaped cross section, which passes through the elliptically shaped hole 35b of the holder guide 35, and holes or recessed portions 36b formed in the disk 36 on a center line defining a diameter thereof at positions which are symmetrical with respect to the center line, the center of which corresponds to the center point of the flat surface of the shaft 36a. Furthermore, reference number 35c denotes a flange portion for causing the holder guide 35 to engage the holder 21, and reference number 35d shown in FIG. 6 denotes an engaging protrusion engaging the cover 165 of the cap 160 to open the discharging hole 161.

The recessed portion 36b has a shape and size so as to engage the protruding portion 163 protruding from the tip end surface of the cap 160 of the toner cartridge 16. When the protruding portion 163 and the shaft 36a engage the recessed portion 36b and the D-shaped hole 35b, respectively, the toner cartridge 16 and the holder guide 35 are integrally rotated while at least the rotational shift therebetween is inhibited. In addition, the gear set 31 has a protrusion 31a engaging a hole which is formed by the cut-out 21c formed in the partition wall 21a of the holder 21, and the cut-out (not shown) of the holder guide 22 facing the cut-out 21c, and an elliptically shaped hole 31b having a shape corresponding to the elliptically shaped hole 35b of the holder guide 35. The tip portion of the shaft 36a of the disk 36 passes through the elliptically shaped holes 35b and 31b to engage the spring 32 while playing therewith, so that the shaft 36a rotatably engages a shaft receiving portion 23a formed in the inner wall of the chamber 23. The shaft receiving portion 23a is shown in the sectional view of FIG. 6 although it is not shown in the exploded perspective view of FIG. 4.

The respective parts with the above described constructions are previously assembled except for the toner cartridge 16. The drive unit 20 is assembled to be mounted on the one end side 17a of the cartridge receiving portion 17, and the inlet holder 18 having the biasing lever 19 is mounted on the other end portion 17b. The drive mechanism 25 of the drive unit 20 is mounted on the inside and outside of the chamber 23 separated by the partition wall 21a of the holder 21, to constitute the gear systems 30 and 31. The holder guide 35 is provided between the partition wall 21a of the holder 21 and the engaging partition wall 21b engaging the flange portion 35c of the holder guide 35 while the disk 36 of the holder guide 35 is mounted. After all of the parts are combined with the holder 21, the holder 21 is covered with the holder cover 22 to be fixed by the shown screw to be assembled, and thereafter, the assembly is fixed to the one end side 17a of the cartridge receiving portion 17.

Referring to FIGS. 5 through 7C, the operations for attaching and detaching the toner cartridge 16 on and from the toner supply device with the above described construction will be described. First, in order to attach the toner cartridge 16 on the drive unit 20, the toner cartridge 16 is horizontally waggled to be sufficiently shaken, the toner cartridge 16 is then inserted into the guide hole 18A of the inlet holder 60 from the side of the cap 160 as shown in FIG. 5. At this time, by inserting the toner cartridge 16 so that the protruding positioning portion 63 of the cylindrical container 60 is coincident with the recessed portion 18C of the inlet holder 18, the discharging hole 161 of the cap 160 is inserted while remaining facing upwards. However, since the discharging hole 161 of the cap 160 is closed by the ring-shaped cover 165 at this time, the cover 165 can also prevent the toner from leaking.

FIG. 6 is a plan view showing the state that the tip portion of the toner cartridge 16 engages the drive unit 20, which is viewed from the top of FIG. 5 to show the holder 21 and the toner cartridge 16 while the holder cover 22 is removed. This figure includes a cross section of only the holder guide 35 and the cover 165 of the cap 160. If the cartridge 16 is further inserted from the position shown in FIG. 6, the protruding portion 163 serving as the positioning portion engages the recessed portion 36b of the disk 36 to cause the tip end surface of the cap 160 to push the disk 36.

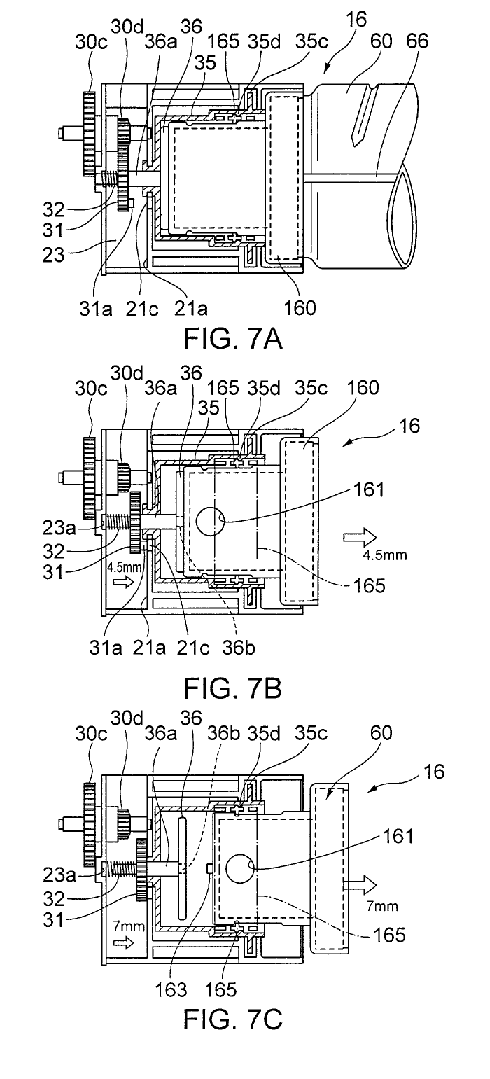

Slightly before this, the engaging protrusion 35d formed on the inner peripheral surface of the holder guide 35 engages the outer stopper 166b of the elastic tongue piece 166 of the cover 165. Thus, the cover 165 slides while the protrusion 167 is guided by the guide groove 164 shown in FIG. 3, so that the discharging hole 161 is open. Thus, the discharging hole 161 is opened exactly in the holder guide 35, and the discharging hole 161 is coincident with the supply hole 35a of the holder guide immediately after the discharging hole 161 is opened. In this state, the protrusion 31a of the gear set 31 engages the hole formed by the cut-out 21c of the holder 21 and the cut-out of the holder cover 22 facing the cut-out 21c. In FIG. 6, the cover 165 moves to the right with respect to the cap 160, so that the inner stopper 166a abuts on the engaging portion 162b. If the cartridge 16 is further thrust, the upper stopper 166b moves to the left in the figure to pass over the engaging protrusion 35d to a position shown in FIG. 7A.

Referring to FIG. 6 again, when the toner cartridge 16 is further thrust as described above, while the tip end surface of the cap 160 presses the disk 36 with the cylindrical portion 163 engaging the recessed portion 36b, the shaft portion 36a contacts the shaft receiving portion 23a against the spring force of the spring 32 to be positioned. In this state, the gear set 31 mounted on the shaft portion 36a meshes with the fourth gear 30d of the gear set 30. This state is shown in FIG. 7A. By driving the motor 26 in this state, the torque of the motor is transmitted by the drive mechanism 25 comprising the gear sets 30 and 31, and the cap 160 and the cylindrical container 60 can be rotated.

Referring to FIGS. 7A through 7C, the operation of detaching the toner cartridge by the drive unit 20 will be described below. In the conventional toner supply device, it is required to stop the rotation of the toner cartridge at a position, at which the discharging hole and the supply hole face upwards, so as to prevent the toner from leaking from the discharging hole of the cap and the supply hole of the holder guide and the like. However, in this embodiment of a toner supply device according to the present invention, the rotation of the toner cartridge 16 can be stopped even if the discharging hole 161 is arranged at any rotational positions.

That is, although the toner cartridge 16 can be stopped even if the supply hole 35a of the holder guide 35 and the discharging hole 161 of the cap 160 are arranged at any positions, the toner supply device of this embodiment is designed so that, when the toner cartridge 16 is intended to be detached in this state, it can be detached only after the protrusion of the gear set 31 engages the engaging hole which are formed by cut-out portion 32C of the partition of the holder 21 and the cut-out portion of the holder cover 22 corresponding to the cut-out portion 32C. Since the protrusion 31a is allowed to protrude by about 4.5 mm as indicated in FIG. 7B, the toner cartridge 16 is shifted by 4.5 mm in a direction indicated by an arrow when the protrusion 31a is fit in the hole formed by the cut-out 21c. The discharging hole 161 and the supply hole (not shown here but 35a in FIG. 4) face upwards while the protrusion 31a is being fit in the hole formed by the cut-out 21c. The 4.5 mm-movement of the toner cartridge 16 releases the gear 30d from engagement with the gear set 31 so that the toner cartridge 16 can rotate freely.

In this state, the discharging hole 161 of the toner cartridge 16 is gradually being closed by the cover 165 shown by the two-dot chain line in FIG. 7B. If this is further extracted, the discharging hole 161 is completely closed as shown in FIG. 7C, so that the discharging hole 161 can remain being closed when the toner cartridge 161 is extracted. In this state, if the disk 36 is further moved by 2.5 mm by the biasing force of the spring 32, the toner cartridge 16 is moved by “4.5+2.5=7 mm” toward the inlet holder 18 as shown in FIG. 7C. In this state, since the bottom portion of the toner cartridge 16 is protruded by at least 7 mm from the inlet holder 18, if the user holds and extracts the bottom portion of the cylindrical container 60 of the toner cartridge 16, the used toner cartridge 16 can be extracted.

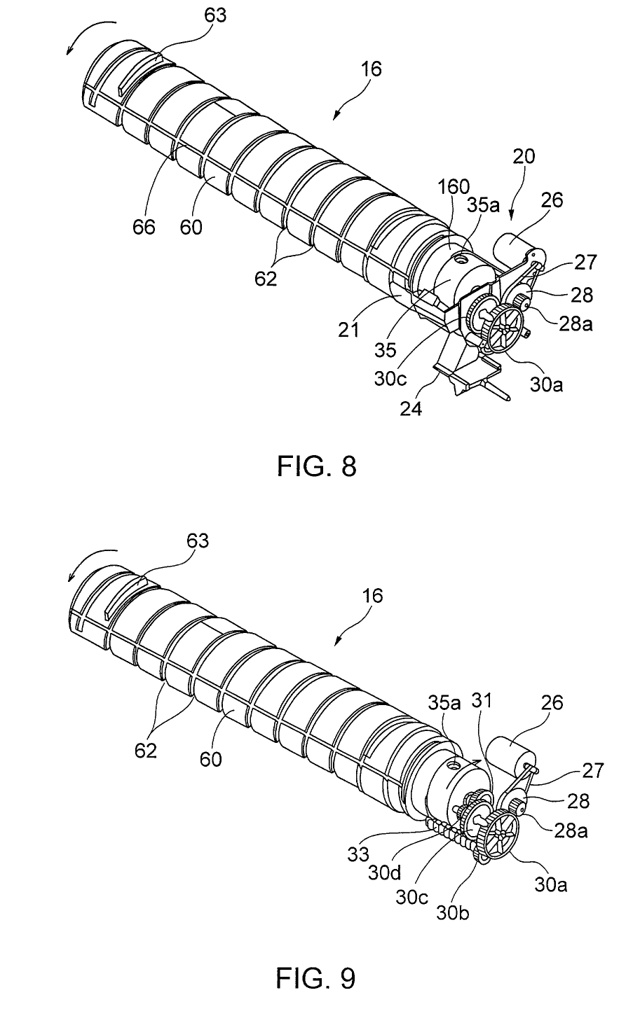

FIGS. 8 and 9 are perspective views illustrating the supply of toner to the developing device 11 from the toner supply device having the configuration described above. Shown in FIG. 8 are the drive unit 20 with the holder 21 and the toner cartridge 16. FIG. 9 is a perspective view showing the toner cartridge 16 and the drive unit 20 with the holder 21 shown in FIG. 8 being omitted therefrom. In the toner supply device attached into the cartridge receiving portion 17 by an operation as described with reference to FIGS. 3 to 6, the motor 26 as a power driver of the drive unit 20 is controlled by a control device (not shown) to rotate the toner cartridge 16 in a direction indicated by an arrow via the drive mechanism 25 such as gears.

While the toner cartridge 16 is rotating, toner is gradually fed through the cylindrical container 60 in a direction of the supply hole 35a along the spiral protrusion formed in the container 60. In a regular use, toner is fed through the cylindrical container 60 while the toner cartridge 16 is rotating in the direction indicated by the arrow. In toner-cartridge replacements toner remaining on the bottom of the cylindrical container 60 can be removed by rotating the toner cartridge in regular rotation in the arrow-indicated direction and reverse rotation in the anti-arrow direction alternately and repeatedly.

Toner is fed out from the toner cartridge 16 through the discharging hole 161 and the supply hole 35a while the toner cartridge is rotating. The toner fed from the toner cartridge 16 is once stored in the carrier auger 33 of the holder 21 and fed towards the developing device 11 through the supply hopper 24 of the holder 21 by the carrier auger 32. Toner is once stored in the carrier auger 32 and fed therefrom, otherwise causing problems such as over toner due to variation in the amount of toner per unit of time supplied through the discharging hole 161 of the toner cartridge 16 and the supply hole 35a. In detail, the carrier auger 32 carries toner while synchronizing with the rotating toner cartridge 16 with engagement of the gear 30a with the gear 30b mounted on the carrier auger 32 via the bush 33.

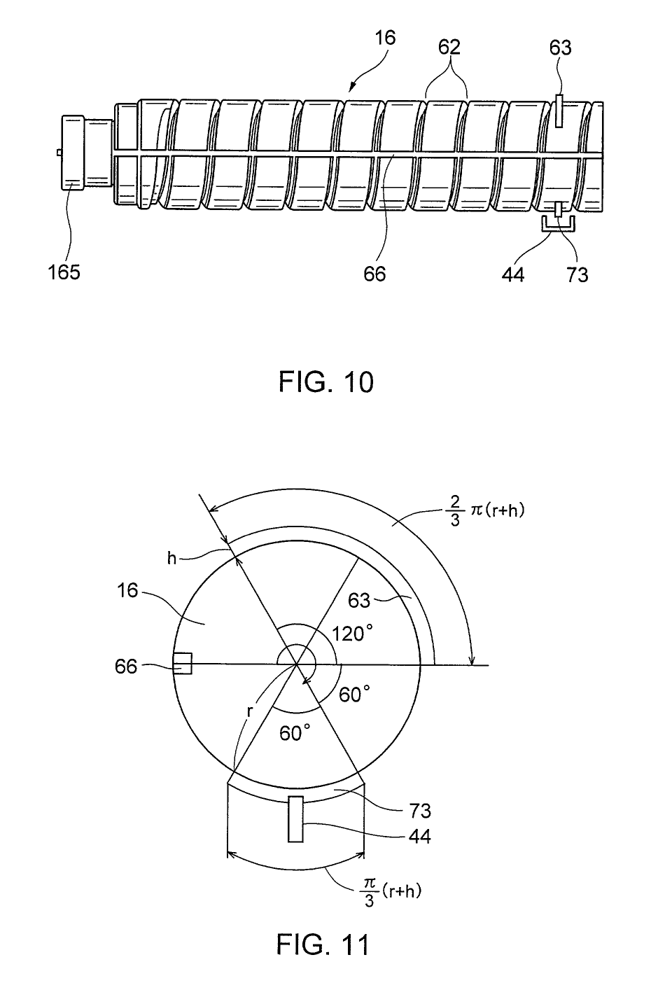

FIG. 10 is a side view illustrating how to determine whether a toner cartridge has been attached and also whether the attached cartridge is a genuine or pirated one. The toner supply device of the embodiment, installed in the copying machine 1, is equipped with a detector 44 such as a sensor, a push-switch sensor, an optical sensor, etc., for detecting the two protrusion portions 63 and 73 of the toner cartridge 16 and their length. As shown in FIG. 10, the detector 44 is turned on when it is depressed by the protrusion portion 73 at the center section thereof whenever a new cartridge is attached.

FIG. 11 is a rear view illustrating the detailed configuration of the protrusion portions 63 and 73, and also a positional relationship between these portions and the detector 44. In this embodiment, the protrusion portion 73 is formed into an arc having a 60°-angle in the rear view while the protrusion portion 63 is also formed into an arc having a 120°-angle on the opposite side of the toner cartridge 16. Moreover, the protrusion portions 73 and 63 are arranged on the opposite sides as having the angle of 60° between the end face (rear face) of the protrusion portion 73 and the end face (front face) of the protrusion portion 63. The lengths of arc for the protrusion portions 73 and 63 are thus ⅓ [symbol] (r+h) and ⅔ [symbol] (r+h), respectively, in which “r” is the radius of cross section on the cylindrical container of the toner cartridge 16 and “h” is the height of the protrusion portions 63 and 73.

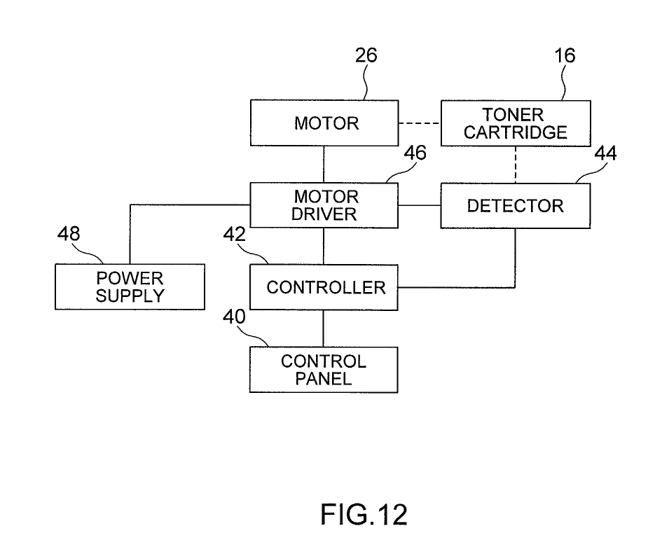

FIG. 12 shows a block diagram of components, among those of the copying machine 1, for detecting a toner cartridge and whether it is a genuine or pirated one.

On attaching the toner cartridge into the copying machine 1, the detector 44 detects whether there is the protrusion portion 73. In detail, the detector 44 detects the protrusion portion 73 when a toner cartridge has a protrusion portion 73 and is attached with protrusion portion 73 being located right downward. A result of detection is sent to the controller 42. The controller 42 determines, based on the signal from the detector 44, that the toner cartridge has been attached, and sends a command signal to the motor driver 46, in response to the command signal, the motor driver 46 drives the motor 26 to rotate the toner cartridge. In this embodiment, the motor 26 rotates the toner cartridge at a constant speed of 60° per second. The detector 44 sends a signal indicating no detection of protrusion portion to the controller 42 when the rear face of the protrusion portion 73 has passed the detector 44 due to rotation of the toner cartridge when a set period of time has elapsed. The detector 44 then detects the protrusion portion 63 of the toner cartridge when the front face of the portion 63 has reached the detector 44, thus sending a result of detection to the controller 42. It further sends a result of detection to the controller 42 when the rear face of the protrusion portion 63 has passed the detector 44. Based on the signals sent from the detector 44, the controller 42 measures a period T_{ON1} from a moment at which the toner cartridge has stated rotation to another moment at which the rear face of the protrusion portion 73 has passed the detector 44, a period T_{OFF} from a moment at which the rear face of the protrusion portion 73 has passed the detector 44 to another moment at which the front face of the protrusion portion 73 is detected by the detector 44, and a period T_{ON2} from a moment at which the front face of the protrusion portion 63 is detected by the detector 44 to another moment at which the rear face of the portion 63 has passed the detector 44. Time T1, T2 and T3 corresponding to measured periods T_{ON1}, T_{OFF} and T_{ON2}, respectively, have already been measured and stored in a memory (not shown) as set periods of time for genuine toner cartridges. The controller 42 retrieves the set periods of time T1, T2 and T3 from the memory (not shown) and compares periods T_{ON1}, T_{OFF} and T_{ON2} measured for an attached toner cartridge with the set time T1, T2 and T3, respectively, to determine whether the attached toner cartridge has protrusion portions on the outer surface thereof, having the standard lengths, thus deciding whether the toner cartridge is a genuine or pirated one. In this embodiment the set time T1,T2 and T3 are 0.5, 1.0 and 2.0 seconds, respectively.

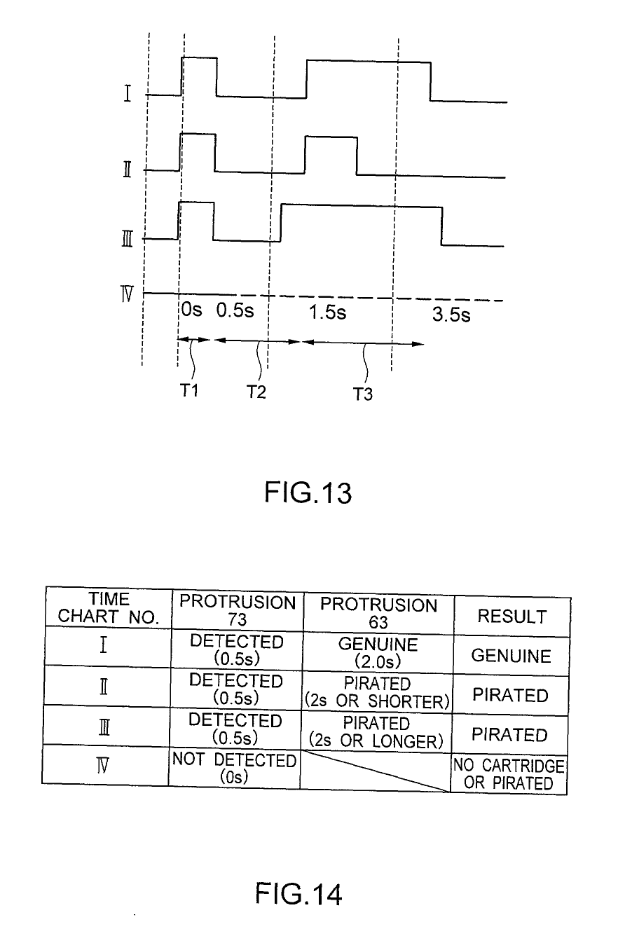

FIG. 13 shows timing charts I to IV for actual signals supplied to the controller 42 when the detector 44 is constituted by a push-switch sensor. FIG. 14 is a table showing results of whether toner cartridges have been attached and they are genuine or pirated ones based on the signals shown in FIG. 13.

First, referring to the timing chart I, it indicates that the measured periods T_{ON1}, T_{OFF} and T_{ON2}, are equal to the set time T1 (=0.5 s), T2 (=1.0 s) and T3 (=2.0 s), respectively, which teaches that the standard protrusion portions 63 and 73 have been arranged on an attached toner cartridge, thus the toner cartridge being a genuine one.

Next, referring to the timing chart II, it indicates that the measured periods T_{ON1} and T_{OFF} are equal to the set time T1 and T2, respectively, but the last measured period T_{ON2} is shorter than 1.0 s, which teaches that the standard protrusion portion 63 has not been formed on an attached toner cartridge, thus the toner cartridge being a pirated one.

In addition, referring to the timing chart III, it indicates that the measured period T_{ON1} is equal to T1, but T_{OFF} is shorter than 1.0 s and T_{ON2} is longer than 2.0 s, which teaches that an attached toner cartridge has the standard protrusion portion 73 but another protrusion is longer than the standard protrusion portion 63, thus this toner cartridge being also a pirated one.

Moreover, referring to the timing chart IV, it indicates that the push switch has not been turned on and hence no signals have not been supplied from the detector 44 to the controller 42, thus teaching no toner cartridges or a pirated one with no protrusion on the outer surface thereof having been attached.

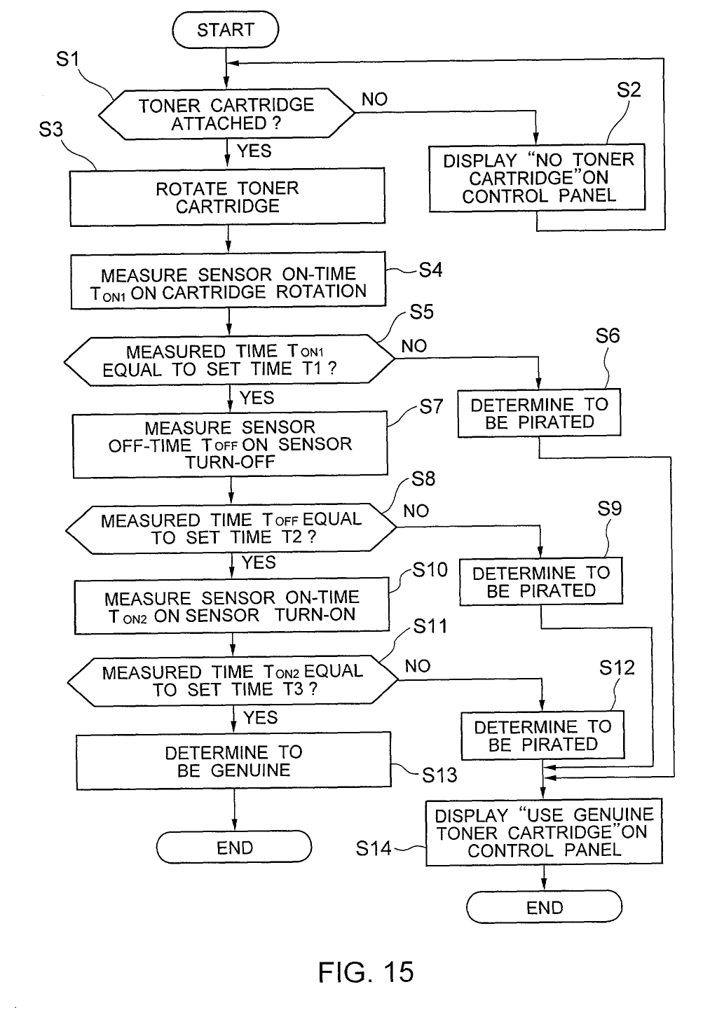

Disclosed next with reference to the flowchart shown in FIG. 15 is how to determine whether a toner cartridge has been attached and also it is a genuine one in a toner supply device of this embodiment installed in the copying machine 1. FIG. 15 indicates a procedure for such determination with a push-switch sensor as the detector 44 of the toner supply device.

The controller 42 checks whether the push switch, the detector 44, has been turned on to determine whether a toner cartridge has been attached (step S1). If the push switch has been turned off, the controller 42 determines that no toner cartridges have been attached, thus sending a command signal to the control panel 40 to indicate “NO TONER CARTRIDGE” (step S2).

On receiving an ON-signal for the push switch from the detector 44, the controller 42 drives the motor via the motor driver 46 to rotate a toner cartridge under the determination that the toner cartridge has been attached (step S3). On rotation of the toner cartridge, the controller 42 measures an ON-time T_{ON1} for the push switch (step S4). The controller 42 then compares the measured ON-time T_{ON1} with the set time T1 (step S5). If the measured ON-time T_{ON1} is not equal to the set time T1, at this moment, the controller 42 determines that the attached toner cartridge is a pirated one (step S6) and displays “USE GENUINE TONER CARTRIDGE” on the control panel 40 (step S14).

On the contrary, if the measured ON-time T_{ON1} is equal to the set time T1, the controller 42 has continued to command to rotate the motor 26 and starts measurement of an OFF-time T_{OFF} for the push-switch sensor when the sensor is turned off (step S7). The controller 42 compares the measured OFF-time T_{OFF} with the set time T2 when measurement of the OFF-time T_{OFF} is complete after the push-switch sensor has been turned on again (step S8). If the measured OFF-time T_{OFF} is not equal to the set time T2, the controller 42 determines that the attached toner cartridge is a pirated one (stepS9) and displays “USE GENUINE TONER CARTRIDGE” on the control panel 40 (step S14).

The controller 42 starts to measure an ON-time T_{ON2} when the push-switch sensor is turned on again (step S10). The controller 42 compares the measured ON-time T_{ON2} with the set time T3 when measurement of the ON-time T_{ON2} is completed after the push-switch sensor has been turned off again (step S11). If the measured ON-time T_{ON2} is not equal to the set time T3, the controller 42 determines that the attached toner cartridge is a pirated one (step S12) and displays “USE GENUINE TONER CARTRIDGE” on the control panel 40 (step S14).

The controller 42 determines that the attached toner cartridge is a genuine one when the measured time T_{ON1}, T_{OFF} and T_{ON2} are equal to the set time T1, T2 and T3, respectively (step S13).

As disclosed above, according to the embodiment, determination as to whether a toner cartridge has been attached and also the attached toner cartridge is a genuine or pirated one are made in accordance with results of detection provided by a single detector. The embodiment thus offers a low-cost and simple-structured toner supply device having a function of determining whether a toner cartridge is a genuine or pirated one.

It is further understood by those skilled in the art that various modifications, changes and equivalents may be made in the invention without departing from the sprit and scope as set out in the accompanying claims.

What is claimed is:

1. A toner supply device used for an image forming system for forming images with toner, for supplying the toner to the image forming system from a toner cartridge containing the toner, a genuine toner cartridge having a cylindrical container with a toner-discharging hole formed on an outer surface of a front capped-end section thereof and at least one protrusion portion formed on an outer surface of a rear capped-end section thereof, the toner supply device comprising:
a cartridge holder to hold a toner cartridge in a horizontal direction, the toner cartridge being rotatable while held by the cartridge holder;
a rotation driver to supply a rotary power to the toner cartridge;
a detector to detect the protrusion portion of the toner cartridge; and
a controller to determine whether the toner cartridge has been attached based on a result of detection from the detector, rotate the toner cartridge via the rotation driver when determined that the toner cartridge has been attached, measure a length of the protrusion portion in a circumferential direction based on a result of detection from the detector while the attached toner cartridge is rotating, and compare a result of the measurement with a length of the protrusion portion of the genuine toner cartridge, thus determining whether the attached toner cartridge is a genuine one.

2. The toner supply device according to claim 1, wherein the genuine toner cartridge includes a first protrusion portion having a first length and a second protrusion portion having a second length different from the first length, the controller measuring lengths of the first and second protrusion portions of the attached toner cartridge in a circumferential direction based on the result of detection from the detector and comparing a result of the measurements and a first standard length and a second standard length already gained from the genuine toner cartridge, thus determining whether the attached toner cartridge is a genuine one.

3. The toner supply device according to claim 2, wherein the first and the second protrusion portions are separated from each other by a specific distance for the genuine toner cartridge,
the controller measuring a distance between a protrusion portion detected first and another protrusion portion detected next for the attached toner cartridge when having a plurality of protrusion portions, and comparing a result of this measurement and the specific distance between the first and the second protrusion portions of the genuine toner cartridge, thus determining whether the attached toner cartridge is a genuine one.

4. The toner supply device according to claim 2, wherein the genuine toner cartridge includes guide grooves provided as facing each other on an outer wall of the cylindrical container, the first protrusion portion being located almost in the middle between the guide grooves when viewed from the rear capped-end section,
the toner cartridge holder including guide protrusion portions provided so as to be engaged with the guide grooves in attaching the genuine toner cartridge, and
the detector detecting whether the attached toner cartridge has the first protrusion portion for the genuine toner cartridge, right after attached.

5. A toner cartridge used in a toner supply device for supplying toner to an image forming system for forming images with the toner, the toner supply device having a rotation driver for supplying a rotary power to the toner cartridge and a detector for detecting at least components of the toner cartridge, the toner cartridge comprising:
a cylindrical container having a spiral protrusion formed on an inner surface thereof, a toner-discharging hole formed on an outer surface of a front capped-end section thereof, and at least one protrusion portion, having a specific length, provided on outer surface of a rear capped-end section thereof, to be used for determining whether the toner cartridge is a genuine one,
wherein the protrusion portion is located at a position which is detectable by the detector when the toner cartridge has been attached to the toner supply device, and
the length of the protrusion portion is measured based on a result of detection by the detector and sent to the toner supply device, as information indicating that the toner cartridge is a genuine one.

6. The toner cartridge according to claim 5, wherein the cylindrical container is provided, on a cylindrical outer surface thereof, with a first protrusion portion having a first length in a circumferential direction and a second protrusion portion having a second length in the circumferential direction different from the first length,
the first length of the first protrusion portion and the second length of the second protrusion portion being measured based on a result of detection by the detector and sent to the toner supply device, as a first information and a second information, respectively, indicating that the toner cartridge is a genuine one.

7. The toner cartridge according to claim 6, wherein the first and the second protrusion portions are separated from each other by a specific distance on the cylindrical outer surface of the cylindrical container,
the distance being measured based on a result of detection by the detector and sent to the toner supply device, as a third information indicating that the toner cartridge is a genuine one.

8. The toner cartridge according to claim 6, wherein the toner supply device includes guide elements that guide the toner cartridge in a horizontal direction when the toner cartridge is attached and a cartridge holder for holding the toner cartridge, the toner cartridge being rotatable while held by the cartridge holder;
two grooves being provided as facing each other on the outer wall of the cylindrical container, to be engaged with the guide elements of the toner holder when the toner cartridge is attached so that the toner cartridge is allowed to be easily attached in the horizontal direction,
the first protrusion portion being formed almost in the middle of the two grooves on the outer wall of the cylindrical container.

9. A method of determining whether a toner cartridge attached to a toner supply device is a genuine one, the toner supply device being used for an image forming system for forming images with toner, the method comprising:
assembling a genuine toner cartridge with a cylindrical container having a toner-discharging hole formed on an outer surface of a front capped-end section of the cylindrical container, and at least one protrusion portion, having a specific length, formed on an outer surface of a rear capped-end section of the cylindrical container;
detecting whether the protrusion portion exists to determine whether a toner cartridge has been attached; and
when determined that the toner cartridge has been attached, measuring a length of the protrusion portion of the attached toner cartridge and comparing the measured length with the specific length for the genuine toner cartridge.

10. The method of determining whether a toner cartridge is a genuine one according to claim 9, wherein the toner supply device has a rotation driver to supply a rotary power to the toner cartridge,
a first protrusion portion having a first length and a second protrusion portion having a second length different from the first length being provided on an outer surface of the cylindrical container of the genuine toner cartridge, further comprising rotating the attached toner cartridge when determined that the toner cartridge has been attached to the toner supply device based on detection of at least one of the protrusion portions,
the length of at least one of the protrusion portions measured for the attached toner cartridge being compared with the first and the second lengths for the genuine toner cartridge.

11. The method of determining whether a toner cartridge is a genuine one according to claim 10, wherein the first and the second protrusion portions are formed as being separated from each other by a specific distance on the outer surface of the cylindrical container of the genuine toner cartridge, the method further comprising, when a plurality of protrusion portions have been detected on the outer surface of the attached toner cartridge, measuring a distance between a protrusion portion detected first and another protrusion portion detected next and comparing the distance with the specific distance for the genuine toner cartridge.

12. The method of determining whether a toner cartridge is a genuine one according to claim 10, wherein the toner supply device includes guide elements that guide the toner cartridge in a horizontal direction when the toner cartridge is attached and a cartridge holder for holding the toner cartridge, the toner cartridge being rotatable while held by the cartridge holder;
two grooves being provided as facing each other on the outer wall of the cylindrical container of the genuine toner cartridge, to be engaged with the guide elements of the toner holder when the toner cartridge is attached so that the toner cartridge is allowed to be easily attached in the horizontal direction, the first protrusion portion being formed almost in the middle of the two grooves on the outer wall of the cylindrical container,
the method further comprising detecting the first protrusion portion to determine that the toner cartridge has been attached.
